(19) United States
(12) Patent Application Publication
(10) Pub. No.: US 2012/0173717 A1
(43) Pub. Date: Jul. 5, 2012

(54) Cloud*Innovator

(76) Inventor: Vince Kohli, San Jose, CA (US)

(21) Appl. No.: 13/342,966

(22) Filed: Jan. 3, 2012

Related U.S. Application Data
(60) Provisional application No. 61/429,062, filed on Dec. 31, 2010.

(51) Int. Cl. G06F 15/173

(52) U.S. Cl. 709/224

(57) ABSTRACT

Cloud*Innovator is a proprietary rules based event driven invention that is fully integrated within the SAP technology framework and is used to enable Cloud capabilities to ensure optimal performance and systems availability through continuous monitoring, metering, auto-provisioning and tuning of systems resources. This includes an intelligence engine to deliver real-time business decisions to ensure precision tuning of the system resources and parameters via advanced automation techniques.

In other words . . . .

Cloud*Innovator—An Intelligent Invention for enabling SAP automation in the Cloud. This is a proprietary rules based event driven invention that is fully integrated within the SAP technology framework and is used to ensure optimal performance and systems availability through continuous monitoring, metering, auto-provisioning and tuning of systems resources. A run-time intelligence engine provides business logic to ensure precision tuning of system resources via advanced automation techniques.

This Invention is based on provisional patent application 61/429,062 filed on Dec. 31, 2010.

The New Title for this non provisional application is Cloud*Innovator (previously named CloudLogic in the provisional application No. 61/429,062)

Cover Sheet

Cloud*Innovator (previously named CloudLogic)

An Intelligent Invention for enabling SAP automation in the Cloud

The purpose of this application is to capture the details of the Cloud*Innovator invention, which includes a background, overview, Intellectual invention design to meet current market challenges. This invention is based on proven best practices and real-life experiences developed over 20 years specific to the SAP suite of business applications, shared infrastructure services, economies of scale, virtualization technologies, Cloud Computing, SOA, and advanced performance analysis and tuning. Cloud*Innovator is a Intelligent rules based event driven invention designed with Monitoring, Metering, and Automated Provisioning of systems resources to maintain optimal performance and uptime.

### BACKGROUND

Cloud*Innovator is designed as a proprietary invention including highly intelligent smart logic that is fully integrated within the framework of the core SAP run-time system. This approach of using built-in intelligence allows the invention to address the key challenges of enabling the principals and techniques of Cloud Computing in a real-time manner with no human intervention required. Through advanced monitoring, metering, and automation, the Cloud*Innovator invention can operate in an auto-pilot mode to most effectively utilize the computing resources available and ensure customer defined Service Level Agreements (SLA) and Service Level Objectives (SLO) are met or exceeded. This fully automated approach will ensure optimal performance and maximum availability across the entire systems landscape including both production and non-production systems alike. Cloud*Innovator is unique in that it provides an embedded intelligence engine that is based on SAP best practices for a specific application and platform combination. In addition to best practices the invention incorporates customer defined business rules and run-time trending analytics to deliver real-time business decisions to ensure precision tuning of the system resources and parameters via advanced automation techniques. Cloud*Innovator is designed for system deployments of all shapes and sizes whether on premise or delivered through a hosting provider. Cloud*Innovator can also be used within traditional non-virtualized static environments to deliver Cloud-Like capabilities to improve overall performance and better utilize the existing computing asset investments. This would apply to those customers who are taking a wait and see approach to cloud enabling their SAP environment.

### SUBJECT MATTER OF THE CLAIMED INVENTION

The adoption of Cloud Computing within the Enterprise application marketplace for systems such as SAP has been slow due to the overall complexity in deploying these solutions as well as the perceived risks associated in moving these mission critical business applications to new and emerging technologies. Integrating the SAP application with the underlying infrastructure and virtualization layers requires subject matter expertise in each of these individual areas as well as extensive knowledge of how they interact with one another. Unfortunately the Cloud solutions being marketed to SAP customers today are rather limited in scope. The primary focus of these solutions is predicated on the auto-provisioning of non-mission critical systems, and is void of any real logic that can allow the system to make corrective actions on its own without human intervention. Many of these solutions have effectively automated the more mundane lower level tasks; but still require knowledgeable resources to make key decisions on the actions to be taken. There has been no investment whatsoever into the intellectual design based on the real business needs of customer wanting to more efficiently manage their full production landscapes. There is no such concept of an auto-pilot or self-management mode, so the complexities of monitoring and managing each disparate level of the technology stack falls directly on the systems administrator or high priced consultants.

Most IT organizations are having difficulty dealing with the phase of change in technology. Along with the major advancements in technology there has been a proliferation of complexity that has been introduced, which available skilled resources have been unable to keep pace with. One of the main challenges with deploying SAP in the Cloud today remains a heavy reliance on highly skilled resources that are necessary to effectively implement the solution. Due to the inherent differences between traditional vs. virtualized SAP deployments, most Basis and System Administrators lack the fundamental knowledge to master these disconnected silos of expertise and are ill prepared to take on such a daunting task. Most of the solutions available today require a high degree of manual administration and technical skill to implement and maintain. These solutions are not intuitive by nature and much like in the early days of SAP the challenges of these emerging new technologies will lead to a dependency on high cost long-term consulting engagements and the retention of skilled in-house resources.

No vendors in the market today have demonstrated the end-to-end knowledge or capabilities to fully realize the potential and benefits of virtualization across all layers of the technology stack and bundle it with standardized solution offerings that are easy to sell, deploy, and manage. Cloud*Innovator seamlessly integrates all layers of the technology stack in order to achieve the maximum benefits of virtualization and Cloud technologies. This is achieved through a holistic top down approach to effectively harmonize the goals and priorities of the business community with those of the IT organization. Cloud*Innovator provides the built-in intelligence and mechanisms necessary to tie together the disparate data points required to make real-time decisions according to industry best practices and customer defined business rules and automatically self manage the system resources to ensure optimal performance.

This section contains description of information related to invention. It contains references to specific problems involved in the prior state of technology which invention is drawn toward.

Current technologies related to the monitoring and administration of complex SAP landscapes are disparate and do not provide the seamless integration that is required to maintain optimal performance and maximum availability of the SAP systems belonging to the SAP landscape. Because of this a great deal of manual intervention is required in order to maintain the SAP system landscape both in the present and in preparation for deployment of anticipated growth factors.

### Automated Deployment of Hardware Resources in a Cloud Based Infrastructure Deployment

There are aspects of existing Cloud technology and deployment strategies that do not address the specific needs of a complex SAP system environment. The Cloud technology that is deployed currently has the capability to automatically allocate hardware processing resources (CPU, physical memory, and storage) where it is required based on workload levels. This is a very effective technology when supporting applications that do not require changes to be made to the technical aspects of an application being serviced by the Cloud in response to the automated changes in capacity that were performed by the Cloud. Due to the complexity of the SAP applications and their respective technology framework, changes must often be made to the SAP systems so that they can effectively take advantage of the processing resources that have been allocated by Cloud automation in order to support the changes in workload levels. The result of this is that the normal advantages that a Cloud deployment provides can be greatly diminished when deployed in support of an SAP landscape. For example one significant advantage that a cloud based infrastructure provides is the ability to automatically deploy physical memory as required in support of increasing workloads, all without the need for manual administration. One issue that exists with SAP systems is that even though the physical memory has been increased automatically by the Cloud functionality, the memory will not be used properly by SAP unless tuning adjustments are made to the SAP system. The reason for this is that SAP when deployed in UNIX and LINUX based implementations have pre defined memory areas, any one of which, when fully depleted, can result in significant performance degradation of the SAP system. If these key SAP memory areas are not tuned to take advantage of the additional physical memory provided by the Cloud functionality the positive impact of having additional memory allocated in a fast and proactive manner can be nullified. In order for the Cloud deployed physical memory to have the positive impact that was intended, a skilled SAP technical resource must first analyze what tuning must be done to take best advantage of the additional memory and then must manually make the required tuning adjustments. The time that is required to perform this analysis and manual tuning nullifies the advantage provided by the dynamic memory allocation provided by the Cloud technology which in this case is a proactive elimination of a potential memory bottleneck. The Cloud/Innovator invention solves this issue by continuously monitoring all Cloud based activity and aspects of SAP memory utilization and allocation then automatically performing all SAP memory tuning that is required to take advantage of all memory provided by the Cloud technology. No manual intervention is required and the full benefit of the quick deployment of physical memory through Cloud based technology is realized. All analysis and tuning is performed within seconds of the memory being assigned by the Cloud.

### Performance Management

The vast majority of all SAP landscapes will have SAP systems that either currently have noticeable performance issues or will at some time in the future regardless of the industry in which the customer belongs and that their SAP system services. These performance issues can be the result of many possible factors. Just a few of these factors could include the introduction of new development, the addition of users, changes in business requirements, or the deployment of additional SAP modules, or changes to existing functionality. The SAP systems collect extensive performance statistics as do other 3^{rd} party monitoring applications, which can be used by highly skilled SAP performance and capacity experts to analyze existing performance issues or to project the impact of anticipated future growth factors. The issue that exists today is that the analysis and subsequent changes required eliminating the performance issues are not undertaken until after the performance degradation becomes noticeable to the end user community. Although SAP collects a wide range of useful performance statistics they are not used in any automated manner to proactively analyze and tune mission critical SAP systems, instead the statistics must be analyzed by experts and manual tuning must be performed both of which can be very time consuming activities. What the Cloud*Innovator Suite provides that is not currently available in the marketplace is continuous automated analysis of performance statistics collected both by SAP and proprietary agents and then performance tuning is automatically performed by the Cloud*Innovator application. The tuning activities identified through the automated analysis are based on extensive experience managing the performance of over 500 SAP systems across all industries. Another unique feather of the Cloud*Innovator invention is that the automated monitoring and analysis can be tied into any of the major Cloud technologies and initiate any required capacity (CPU, physical memory, and disk) that may be required to head off a performance issue. The continuous cycle of monitoring, analysis, tuning, and resource deployment ensures that performance issues are addressed well before they become significant and noticeable.

### Growth Factor Simulation and Accurate Sizing of Hardware Resources

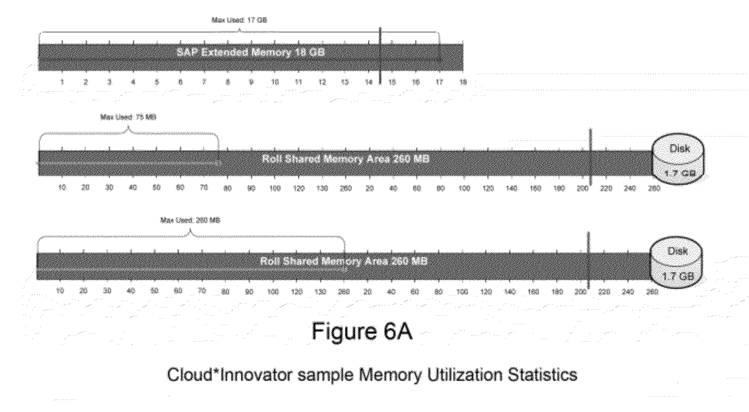

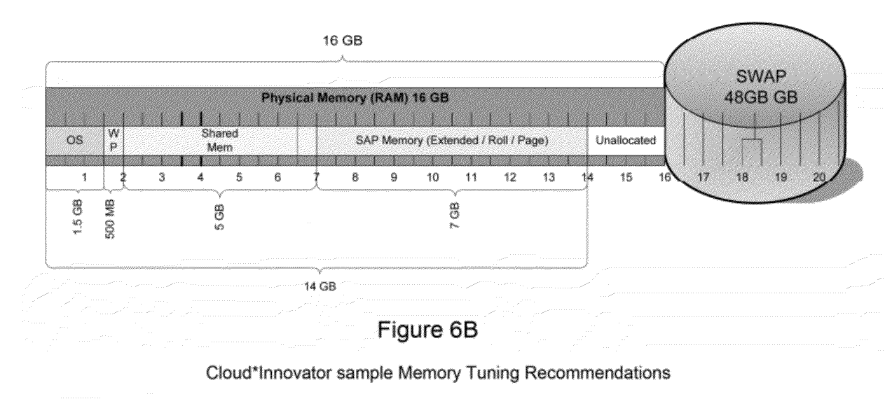

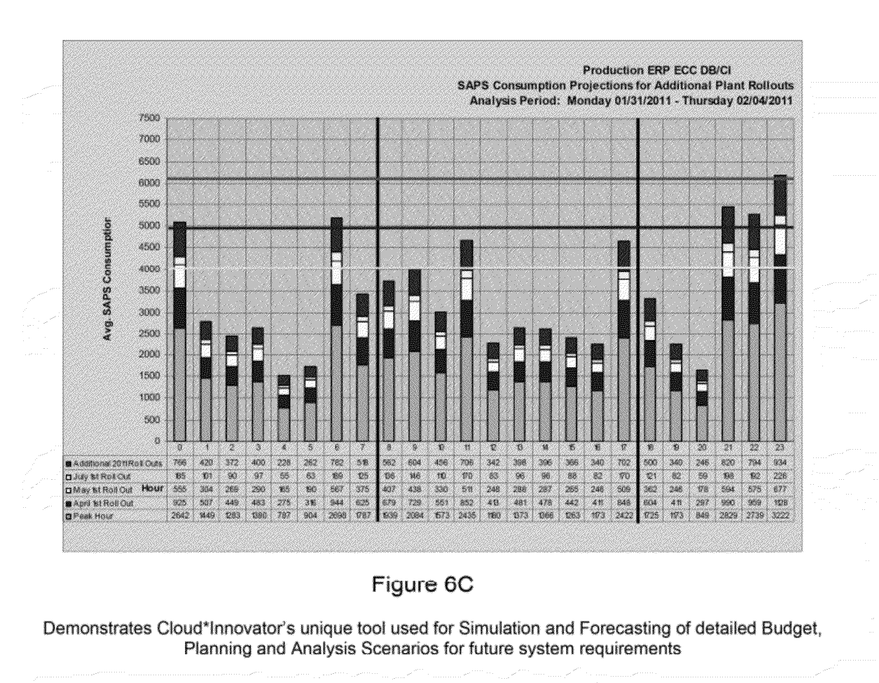

A significant issue with existing SAP deployments is related to improper sizing of hardware resources in preparation of anticipated changes to the workload levels of an SAP system. Often the hardware sizing is not based on the existing workload levels and specific processing characteristics which results in significant performance degradation after the growth factors are deployed. In many cases sizing exercises are not even performed because it requires a special skill set to size an existing production SAP system correctly in preparation of anticipated changes. There are no technologies that exist today that perform automated growth factor simulations based on existing workload levels and processing characteristics specific to a SAP system. There are many sizing applications available that will estimate a SAPS capacity requirement based on existing workload however they only provide a required capacity number and do not take into consideration the existing capacity and architecture in order to make very specific recommendations to enhance existing capacity. The Cloud*Innovator Suite provides the ability to enter simple data related to any anticipated growth factors through an intuitive portal web based interface. The Cloud*Innovator suite will then analyze the existing workload levels, processing characteristics specific to that SAP system, the existing hardware capacity and architecture, and provide accurate simulation graphs (refer FIG. 6C) and very specific sizing and architecture recommendations. The portal interface will also allow the user to simulate the workload associated with the anticipated growth factor for every recommended sizing and architecture option provided by the automated analysis. In the case of Cloud deployments the user will be able to fully implement any recommendation provided by simply selecting the option for activation from the web portal.

### BRIEF SUMMARY

This section presents the substance or general idea of the claimed invention in summarized form. The summary points out the advantages of the invention and how it solves previously existing problems (problems identified in the background of the invention)

Cloud*Innovator was designed based on proven best practices, real-life experience, and knowledge gained over the past 20 years specific to SAP systems management: shared infrastructure services, economies of scale, virtualization technologies, Cloud computing, SOA, hosted environments, and advanced automated performance analysis and tuning. Cloud*Innovator builds upon the concepts of SAP's native Adaptive Computing Controller (also known as the SAP Landscape Manager) and various virtualization technologies available by providing real-time intelligence used for automated decision logic at run-time to effectively manage all computing resources and aspects of the systems landscape. The actions taken at run-time are based on best practices, trending metrics, and customer defined priorities. This approach takes the complexity out of the equation by bringing the administrative decision points up a level, which can be configured according to key business terms such as SLA's and SLO's.

Cloud*Innovator invention utilizes advanced logic developed and refined to automatically resolve issues, tune systems according to specific workload levels and processing characteristics, and ensure that server hardware capacity is available when it is required through automated allocation of CPU, memory, and disk resources, all without interruption to the end user processing. As a result the time required to maintain optimal performance and maximum availability of the system is greatly reduced. Scheduled maintenance requirements are also reduced. The proprietary components that comprise of the invention are developed within the framework of the SAP system (ABAP, JAVA) to ensure complete integration as well as leverage the rich features already included in the native SAP system such as Solution Manager, Adaptive Computing Controller, and Security to name a few. This proprietary layer complements the core SAP functionality by providing the run-time intelligence to automatically manage the system resources.

There are many applications available in the marketplace that performs the technical administration tasks associated with maintaining the SAP landscape. There are monitoring capabilities both in SAP as well as those offered by other software vendors that are very good at collecting data, sending alerts and in some cases even suggesting vague solutions to issues that arise within the SAP system. The problem with these monitoring applications is that system administrators, technical architects, and SAP sizing experts must first interpret the alerts, research solutions, and finally implement the solutions according to industry best practices for that specific applications and platform combination. This process is very time consuming resulting in lingering issues, performance degradation, and in the worst cases unscheduled systems downtime. The technical management of the SAP landscape and its supporting hardware infrastructure requires a highly trained staff consisting of subject matter experts in many different technical disciplines. A typical SAP landscape will require skilled resources in the following areas:
Operating System Administration
Hardware Engineer
Storage Area Network Administration
Network Administration
Advanced SAP Basis Administration
Database Administration

Through intelligent design, Cloud*Innovator effectively becomes your virtual Chief Systems Architect and Basis Administrator by providing available options, preferred recommendations, clear guidelines where necessary, and automated workflows to keep the SAP systems operating at peak levels to exceed or meet pre-defined SLA's and SLO's. This invention provides full visibility and insight to all layers of the technology stack from infrastructure and operating systems up through the database and SAP application tier.

### DETAILED DESCRIPTION OF THE INVENTION

This section explains the process of making and using the invention

### DESCRIPTION OF THE PREFERRED EMBODIMENT

### Invention Approach

Cloud*Innovator for SAP is designed to be a fully automated event driven business rules based invention that leverages virtualization technologies and the concepts of Cloud Computing. This invention is fully integrated into the SAP framework and is designed to be a non-intrusive complementary application that is highly configurable and provides the intelligence and decision making logic to automatically manage the allocation of all computing resources within the SAP systems landscape. This follows the approach of creating a single centralized pool of computing resources and dynamically allocating those resources at run-time to the systems applications that have the highest priorities based on customer defined business rules and SAP best practices by application and platform. These customer defined priorities can be assigned to a specific SAP application such as ECC, BW, CRM or etc and have their requirements setup for specific processing events such as Month-End, Quarter-End, Year-End, and Seasonal Peak Periods. Priorities can also be assigned by date and time in order to reallocate systems resources as necessary in addition to changing the processing modes from On-line Dialog to Batch in an effort to better support the type of workload during peak and off-hours. Priorities can also be assigned for non-production instances to better support in-flight project development activities. Cloud*Innovator provides ultimate visibility and control to the business owner while making the underpinnings and complexities of the systems architecture transparent.

The core building blocks of the centralized resource pool include CPU Cores, Memory, SAN, and Network Bandwidth. The systems are sized and managed according SAPS, which is SAP's own standard unit of method for systems throughput based on published benchmarks by hardware vendor. The individual SAP work processes (dialog, batch, update, etc) will be monitored on the fly to determine if any adjustments are necessary to achieve optimal performance. The system will dynamically adjust the system parameters in relation to the computing resources allocated to optimize the systems throughput for a particular workload.

### Modular Design

The modular architecture of the Cloud*Innovator invention is designed with a Central Intelligence Engine and supporting Smart Modules that are tightly integrated within the native framework of the core SAP system. Cloud*Innovator is designed to be a non-intrusive application add-on component installed within the SAP Solution Manager application with light-weight Live Agents also being installed on all other applications within the overall SAP systems landscape.

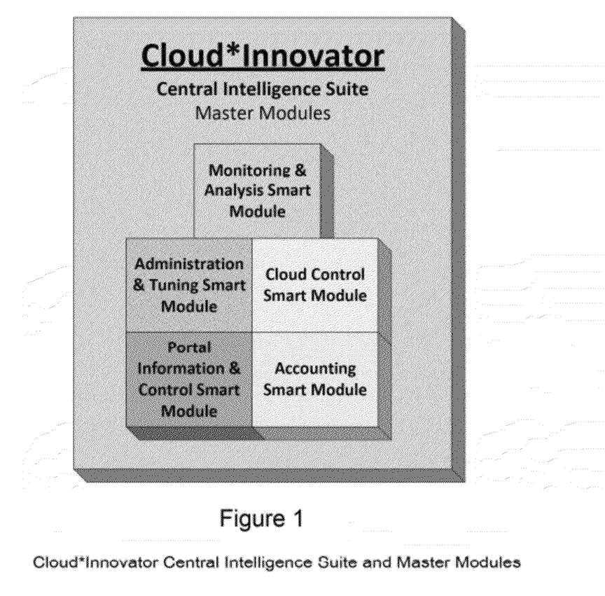

The core component of this Invention is the Central Intelligence Suite (refer to FIG. 1), which is used to manage all technical aspects of the SAP systems landscape and based on the automated analysis of key

statistics and real time system conditions will take the necessary action to automatically allocate or reallocate the necessary system resources. This includes the ability to fully automate the dynamic deployment of hardware resources and SAP Instances within a Cloud based infrastructure. This invention can also be used in traditional non-virtualized landscapes to deliver Cloud-Like capabilities as well. This capability helps to ensure optimal performance and the highest levels of availability in addition to ensuring that peak processing periods will not experience performance degradation due to lack of adequate server capacity. The modular architecture provides the ability to customize the application for specific needs using a web based portal administration dashboard. Functions can be activated or deactivated depending on the specific characteristics of the SAP systems and supporting hardware infrastructure.

The Cloud*Innovator Central Intelligence Suite consolidates the disparate technology components and system administration activities that are required to maintain the SAP system landscape in an optimal fashion. This operates as the central control function for both proprietary technology and technology provided by SAP and other 3^{rd} party administration and monitoring applications to fully automate the tuning and administration of the SAP system landscape. The Cloud*Innovator Central Intelligence Suite consists of five master Smart Modules, each of which contain other sub modules whose functionality can be customized, activated or deactivated. These five master Smart Modules are also shown in FIG. 1.

### Core Components

Cloud*Innovator consists of both non-proprietary as well as proprietary components that make up the operational aspects of the Invention. Definitions for these core components can be found below.

### Non-Proprietary Components

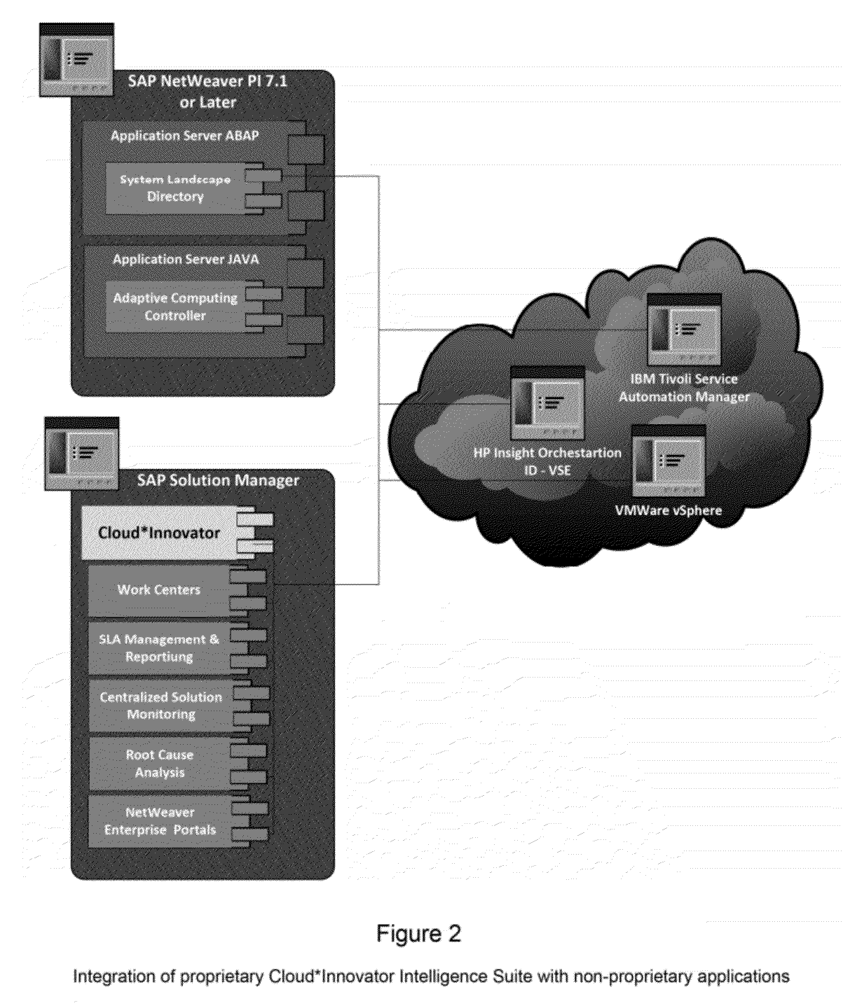

The Cloud*Innovator invention is fully integrated within the fabric of the core SAP application. The proprietary components of the invention are developed using standard SAP methods and tools. The Cloud*Innovator invention is designed to operate as an add-on component to the SAP Solution Manager system with Live Agents and Monitoring Probes installed on all other host systems within the landscape. The key non-proprietary components that are tightly integrated with the Cloud*Innovator invention is defined as follows (refer to FIG. 2):

### SAP Solution Manager:

The proprietary Central Intelligent Engine will be developed and reside on the SAP Solution Manager Application. The SAP Solution Manager End to End Diagnostics and Centralized Solution Monitoring functionality will be deployed by the Central Intelligent Suite as a central repository of SAP statistics for the entire SAP system landscape. The Solution Manager Service Level Reporting functionality will also be used by the Central Intelligent Suite for trending and reporting purposes. The NetWeaver Enterprise Portals usage type will be activated in the Solution Manager application for reporting and manual management functionality. Proprietary JAVA programs will render the portal content for reporting and manual management.

### SAP Process Integration:

The proprietary Central Intelligent Engine will utilize key features within the SAP NetWeaver Process Integration system. The SAP Adaptive Computing Controller component will be used to dynamically manage computing resources available to the SAP landscape. Although other dynamic computing resource management applications will be used by the Central Intelligent Engine the default resource deployment application that will be used is the SAP Landscape Manager also referred to as the Adaptive Computing Controller (ACC) component and the others will only be utilized when the SAP ACC can't service the requirement.

### IBM Tivoli Service Automation Manager:

If and when deployed, the IBM Tivoli Service Automation Manager will be used by the proprietary Central Intelligent Engine to dynamically adjust computing resources (CPU, physical memory, and disk storage in response to fluctuations in workload levels and processing characteristics. The IBM Tivoli Service Automation Manager will be used for SAP systems that are deployed on IBM UNIX server hardware with the AIX operating system. This application will be used by the proprietary Central Intelligent Engine only if the dynamic adjustment of resources requirement can't be satisfied by the functionality of the SAP Adaptive Computing Controller. The proprietary Smart Modules will communicate directly with the IBM Tivoli Service Automation Manager via XML documents that will be read by scripts that will perform the necessary dynamic computing resource adjustments.

### Hewlett-Packard Insight Orchestration ID-VSE:

If and when deployed, the Hewlett-Packard Insight Orchestration ID-VSE application will be used by the proprietary Central Intelligent Engine to dynamically adjust computing resources (CPU, physical memory, and disk storage in response to fluctuations in workload levels and processing characteristics. The Hewlett-Packard Insight Orchestration ID-VSE application will be used for SAP systems that are deployed on HP UNIX server hardware with the HPUX operating system. This application will be used by the proprietary Central Intelligent Engine only if the dynamic adjustment of resources requirement can't be satisfied by the functionality of the SAP Adaptive Computing Controller. The proprietary Smart Modules will communicate with the Hewlett-Packard Insight Orchestration ID-VSE via XML documents that will be read by scripts that will perform the necessary dynamic computing resource adjustments.

VMWare vSphere:

If and when deployed, the VMWare vSphere functionality will be used by the proprietary Central Intelligent Engine to dynamically adjust computing resources (CPU, physical memory, and disk storage in response to fluctuations in workload levels and processing characteristics. The VMWare vSphere functionality will be used for SAP systems that are deployed on Intel/AMD based systems with the Windows or Linux operating systems. This application will be used by the proprietary Central Intelligent Engine only if the dynamic adjustment of resources requirement can't be satisfied by the functionality of the SAP Adaptive Computing Controller. The proprietary Smart Modules will communicate directly with the VMWare vSphere functionality via XML document that will be read by scripts that will perform the necessary dynamic computing resource adjustments.

### Proprietary Components

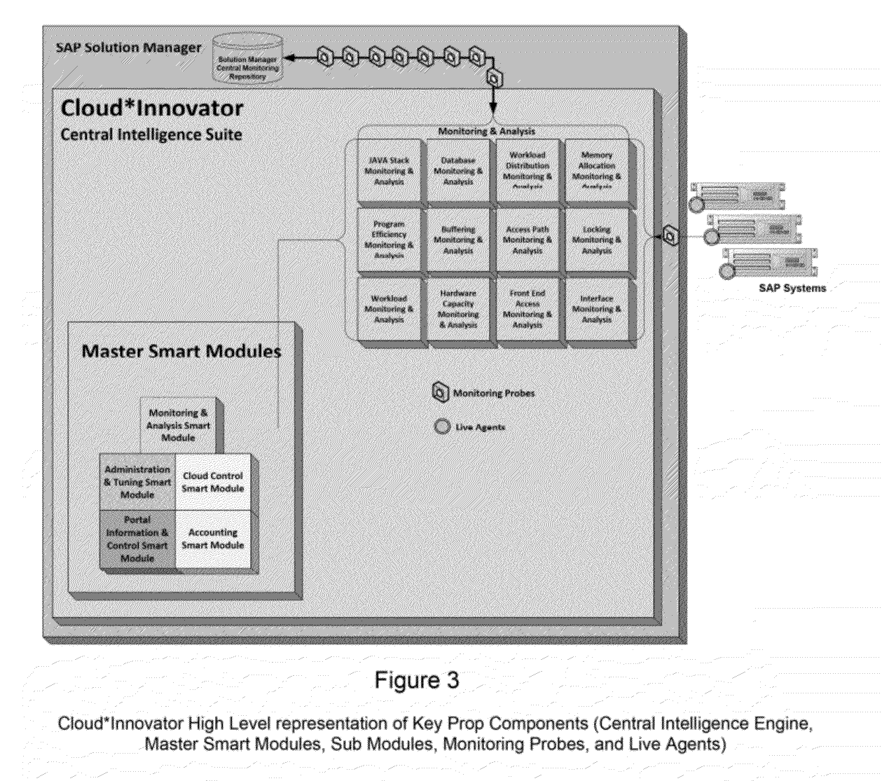

The Central Intelligence Suite consists of application, utility, and agent components that provide for automated monitoring and management of performance, capacity, and availability of all SAP systems within the SAP system landscape and their corresponding hardware resources. The Cloud*Innovator Central Intelligence Suite consists of the following proprietary components (refer to FIG. 3):

### Monitoring & Analysis:

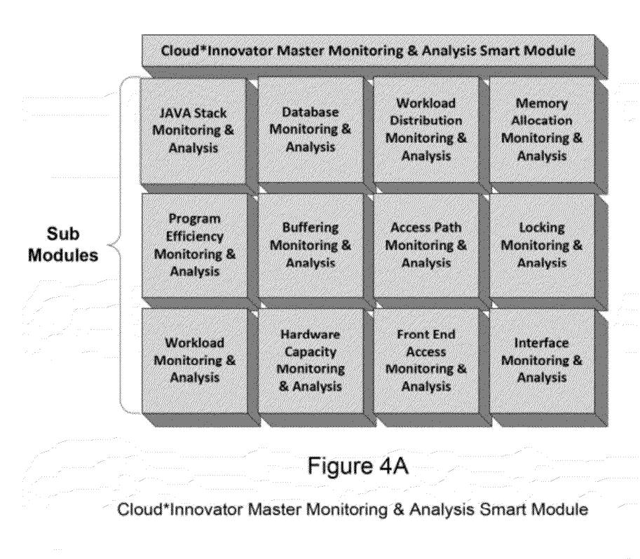

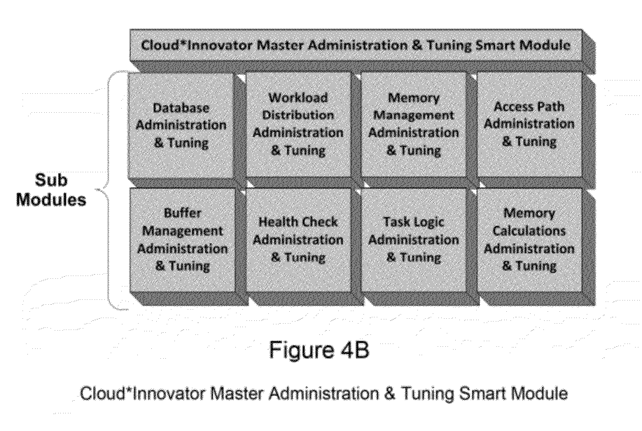

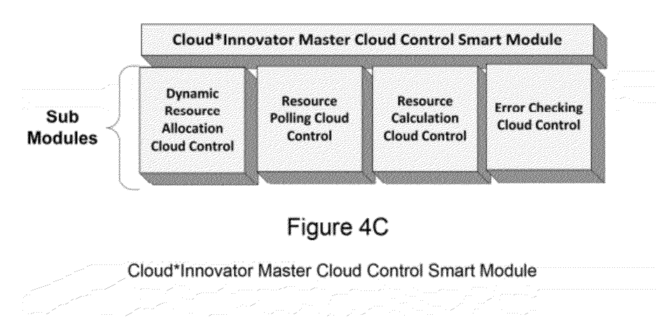

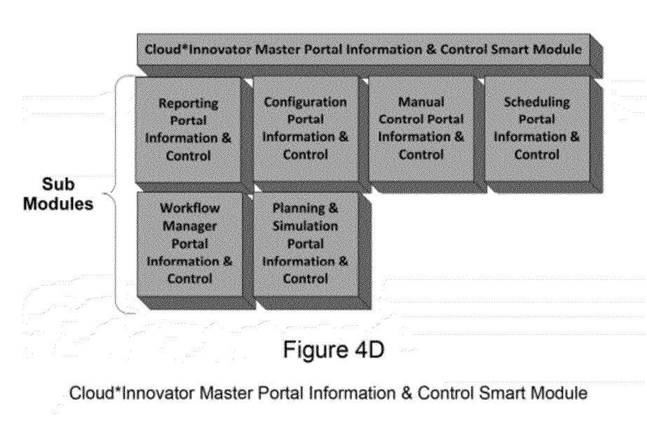

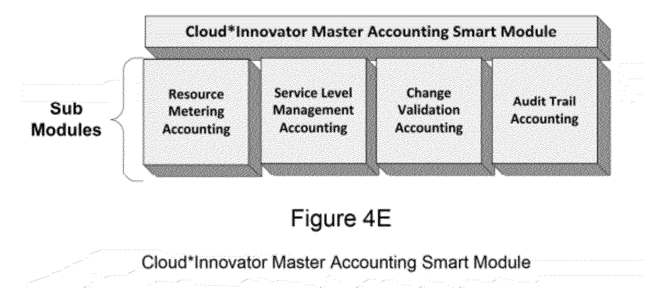

This Master Module provides the continuous polling and monitoring of all the SAP applications and resources deployed in the systems landscape by interpreting the statistics provided through the various monitoring probes in a real-time fashion. These statistics include system level metrics such as cpu utilization, swap space, memory utilization, disk space utilization, as well as database objects, memory buffers, log files, table spaces and lock entries to name a few. The data collected is analyzed in real-time fashion against pre-defined thresholds to determine what if any corrective action needs to be taken. What's unique about Cloud*Innovator is that is not only monitors the system resources currently in flight, but also monitors for idle resources that can be reallocated as needed. This approach provides a panoramic view of the entire environment. The Monitoring & Analysis Master Module includes the following Sub Modules (refer to FIG. 4A):

### JAVA Stack Monitoring & Analysis:

Used to proactively monitor and analyze all JAVA components of the systems landscape according to best practices and raise exceptions as necessary for corrective action

### Database Monitoring & Analysis:

Used to proactively monitor and analyze all the Database Management Systems in the landscape according to best practices and raise exceptions as necessary for corrective action

### Workload Distribution Monitoring & Analysis:

Used to proactively monitor and analyze the overall systems Workload Distribution according to best practices and raise exceptions as necessary for corrective action

### Memory Allocation Monitoring & Analysis:

Used to proactively monitors all Memory Allocation in the systems landscape according to predefined thresholds raise exceptions as necessary for corrective action

### Program Efficiency Monitoring & Analysis:

Used to proactively monitor the systems Program Efficiency according to best practices and raise exceptions as necessary for corrective action

### Buffering Monitoring & Analysis:

Used to proactively monitor the system Buffers according to best practices and raise exceptions as necessary for corrective action

### Access Path Monitoring & Analysis:

Used to proactively monitor the systems indexes and Access Path according to best practices and raise exceptions as necessary for corrective action

### Locking Monitoring & Analysis:

Used to proactively monitor the systems object Locking according to best practices and raise exceptions as necessary for corrective action

### Workload Monitoring & Analysis:

Used to proactively monitor the overall systems Workload according to best practices and raise exceptions as necessary for corrective action

### Hardware Capacity Monitoring & Analysis:

Used to proactively monitor and analyze the overall Hardware Capacity available and required according to best practices and raise exceptions as necessary for corrective action

### Front End Access Monitoring & Analysis:

Used to proactively monitor and analyze the systems Front End Access according to best practices and raise exceptions as necessary for corrective action

### Interface Monitoring & Analysis:

Used to proactively monitor and analyze system Interfaces according to best practices and raise exceptions as necessary for corrective action

### Administration & Tuning:

This Master Module takes the input from the Monitoring & Analysis Module and determines what “task type” needs to be done in order to meet the current request. Depending on the action to be taken the Administration & Tuning Module will send parameters to the CloudControl Module to determine available systems capacity and then will invoke the necessary scripts on the corresponding Live Agents to make the system changes. This module determines what needs to be changed based on the results of the monitoring and sends a change request to the Live Agent on the system that needs to be changed. The Administration & Tuning Master Module includes the following Sub Modules (refer to FIG. 4B):

### Database Administration & Tuning:

Used to automatically determines the corrective actions required to administer and tune the Database Management Systems in the landscape according to best practices

### Workload Distribution Administration & Tuning:

Used to automatically determine the corrective actions required to administer and tune the overall systems Workload Distribution according to best practices

### Memory Management Administration & Tuning:

Used to automatically determine the corrective actions required to administer and tune the systems landscape Memory Allocations according to best practices

### Access Path Administration & Tuning:

Used to automatically determine the corrective actions required to administer and tune the systems Access Path according to best practices

### Buffer Management Administration & Tuning:

Used to automatically determine the corrective actions required to administer and tune the system Buffers according to best practices

### Health Check Administration & Tuning:

Used to automatically determines administrative and tuning actions required for systems Health Checks according to best practices

### Task Logic Administration & Tuning:

Used to automatically determines administrative and tuning actions required for systems Task Logic according to best practices

### Memory Calculations Administration & Tuning:

Used to automatically determines optimal Memory Calculations based on resources available to be used for systems administration and tuning according to best practices

### Cloud Control:

This Master Module is used to continuously poll the pool of available resources to determine what can be allocated if and when needed. It's also responsible for dynamically requesting resource allocation based on the required changes needed for the system. This Master Module interfaces directly with the utilities such as TSAM, HP Insight, VMware vSphere, and others. The Cloud Control Master Module includes the following Sub Modules (refer to FIG. 4C):

### Dynamic Resource Allocation Cloud Control:

Used to automatically take the necessary action to Dynamically Allocate Systems Resources including CPU and RAM according to best practices

### Resource Polling Cloud Control:

Used to automatically Poll System Resources on a continual basis to be used for proactive decision making based on best practices

### Resource Calculation Cloud Control:

Used to automatically Calculate System Resources based on what is available in the available pool of resources compared to what's required according to best practices

### Error Checking Cloud Control:

Used to automatically perform Error Checking routines to validate that the changes being applied to the systems landscape were successfully carried out

### Portal Information & Control:

This Master Module provides the systems administrator the ability to manually submit change requests, configure business rules, download updates, set thresholds and alerts, and configures workflow requirements. The Portal Information & Control Module can also be used to generate various reports on the systems performance including historical trending analysis and metering statistics. This module can also be used for planning and simulation purposes to take a visionary look into the future at various “what if” scenarios to determine if any additional resources would be required. The Portal Information & Control Master Module includes the following Sub Modules (refer to FIG. 4D):

### Reporting Portal Information & Control:

Used to manually manage and generate advanced Reporting Information including historical trending analysis and metering statistics and other details captured during run time

### Configuration Portal Information & Control:

Used to manually enter Configuration details including customer defined business rules that are used in conjunction with best practices and trending analysis to manage the system

### Manual Control Portal Information & Control:

Used to Manually Control all aspects of the Cloud*Innovator system to override auto-provisioning of resources and operate in a manually controlled mode

### Scheduling Portal Information & Control:

Used to manually setup and maintain the Scheduling of batch processes that need to be performed according to pre-defined timelines

### Workflow Manager Portal Information & Control:

Used to manually setup and maintain pre-defined Workflow processes to provide notifications, raise alerts, and carry out manual corrective actions as necessary

### Planning & Simulation Portal Information & Control:

Used for Planning and Simulation purposes to take a visionary look into the future at various what if scenarios determine systems capacity requirements

### Accounting:

The Accounting Master Module is used to track and log all changes made to the system for historical auditing purposes and also provides metered statistics and reporting detail for customer defined service levels. This also provides capabilities for customer's regulatory validation requirements. The four sub modules are as follows (refer to FIG. 4E):

### Resources Metering Accounting:

Used to automatically track and log all details related to Resource Metering and make this information available for reporting on ranges and trending analysis over a given time period as specified

### Service Level Management Accounting:

Used to automatically track and log all details related to the defined Service Level Management requirements and make this information available for reporting and trending analysis

### Change Validation Accounting:

Used to automatically track and log all details related to Change Validation including all manual and auto-provisioned activities associated with the systems landscaped

### Audit Trail Accounting:

Used to automatically track and log all details related to Audit Trail management and make this information available for reporting for auditing purposes

### Operational Modes:

Cloud*Innovator includes 3 distinct modes of operation from which the invention can run depending on the level of control the administrator wants to maintain on the system. Some customers will want to fully automate all aspects of the management of their SAP systems landscape to ensure optimal performance and avoid potential human error. Other customers may prefer to keep tight control over their systems landscape and use Cloud*Innovator as a resource to provide subject matter expertise and clear easy to use guidelines to manually administer the system. The fully automated mode can also be configured to include customer defined workflow approvals. The Cloud*Innovator Central Intelligence Suite consists of the following Operational Modes:

### Manual Mode:

In this mode the systems administrator will have full control over the management of the systems landscape and can use the Portal Control Manager to initiate self-service requests to take the necessary action to update the systems as required. In this mode Cloud*Innovator acts as a trusted advisor and does all the leg work necessary to analyze the systems performance and propose any recommended changes and alternative options that should also be considered. With Cloud*Innovator having complete visibility to the health, care, and feeding of the system it can propose clear guidelines for the administrator to take as corrective action for any given event or predefined threshold that has been exceeded. The Manual Mode enjoys the same overall benefits that are offered in the Auto-Pilot Mode, except the auto-provisioning is switched off in favor of a manually provisioned approach.

### Scheduled Mode:

In this mode the Cloud*Innovator invention is able to automatically provision system changes based on predefined scheduled events. This would commonly be used for predictable changes in workload such as off hours when there are fewer online user and batch processing runs are kicked off. This allows the system to automatically mobilize the needed resources for batch processing by switching online dialog work processes to batch processes, adding additional update processes, and moving resources from other applications and non-production instances to better support off-hours activities. What's unique with Cloud*Innovator is that in addition to scheduling SAP operational modes related to work processes, it's also able to reallocate idle resources that can be used to better balance the workload and shorten the batch window. Another scenario for pre-scheduled modes could include planned maintenance activities where the SAP applications are moved from one server resource to another to allow for updates to the infrastructure. This mode can be set up to run in conjunction with either the Manual or Auto-pilot modes.

### Automated Mode:

Also known as Auto-Pilot, this mode the Cloud*Innovator invention is continuously polling the systems landscape for monitoring statistics and automatically takes any corrective actions necessary to maintain optimal systems performance. This continuous monitoring of thresholds, triggers, alerts, and system health checks is used to determine if any events are raised that require a systemic intervention to adjust system resources, initiate workflows, or send an alert. This mode offers a fully automated end-to-end process aimed at harmonizing the workload with the system resources available, which is based on SAP best practices, customer defined business rules, and historical trending analysis. The Auto-pilot Mode takes away all the guesswork and offers the best all around approach for reducing the overall TCO and accelerating the ROI.

### Sample Process Flows:

### Dynamic CPU Compensation for Peak Workload Requirements Flow:

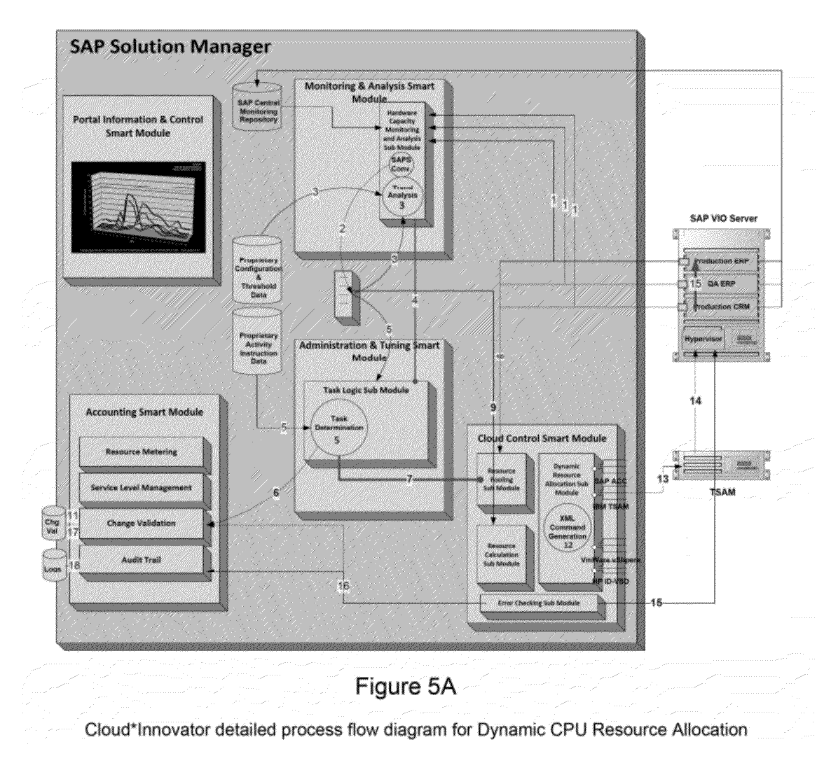

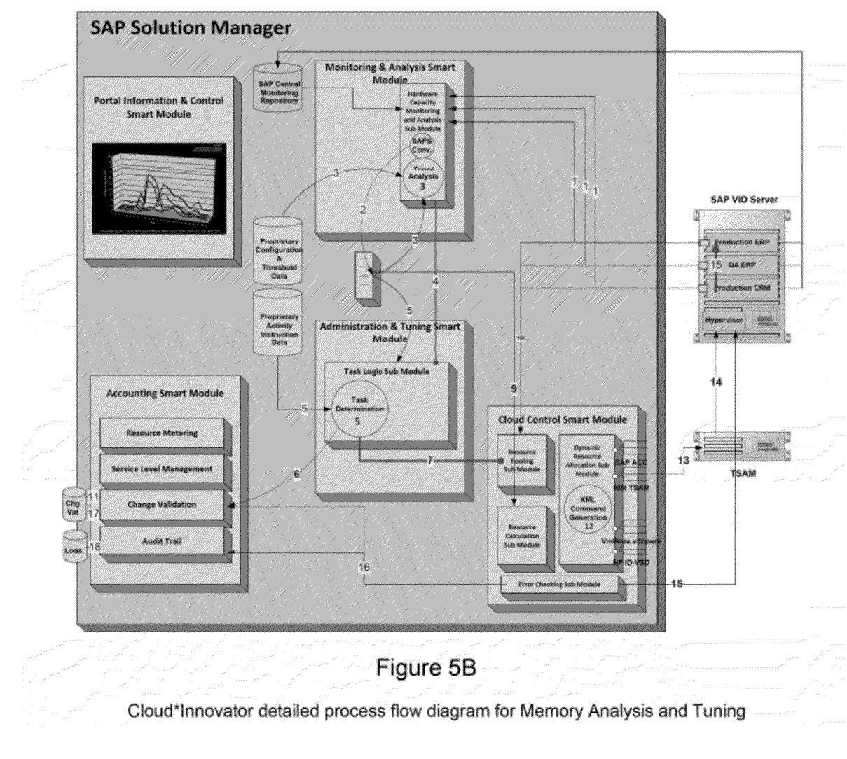

There are many methods in which the central intelligence engine of the Cloud*innovator suite can deploy additional CPU resources based on workload levels. The method used depends on the specifics of the condition and operational mode used to generate the change process (manual, automated, and scheduled). The process flow below is based on the automated mode following scenario (refer to FIG. 5A):

### Scenario Details

### Example Condition:

The process flow in this example is used to automatically manage the computing resources required to process the increased workload associated with month end processing. This workflow in this example would manage the condition where the average workload of the production ERP ECC system requires 5 CPU cores however in order to complete month end processing within a required timeframe that is dictated by specific business requirements 5 additional CPU cores are required. The process that is performed to satisfy month end processing is completely automated based on real time monitoring and analysis which is unique to the industry. The process requires no administrator intervention or expert analysis, and no down time for the production system. Without the Cloud*Innovator automation and intelligence the solution to this condition could require constant manual monitoring, hours of analysis related to workload in relation to available resources of all logical partitions, and possible production system downtime.

The following example scenario illustrates how the Cloud*Innovator invention effectively ensures that mission critical SAP systems maintain optimal performance and maximum workload throughput by automating the allocation of CPU resources based on constant monitoring of the workload levels and hardware resource consumption.

### Master Module: Monitoring and Analysis

### Sub Module: Hardware Capacity Monitoring and Analysis

1.) CPU utilization, workload characteristics, and the logical partition configuration (CPU and physical memory) are pulled from all SAP systems using proprietary agents that are installed on each SAP system. Statistics are generated and pulled at 5 second intervals.
2.) The statistics are converted to a SAPS benchmark consumption value which is loaded into “in memory” tables for short time trending analysis. This trending analysis is performed in order to determine where additional CPU resources might be needed.
3.) Short term trending analysis is performed on the SAPS consumption levels which is compared to key performance level thresholds in order to determine if additional CPU resources are required. In this example month end processing has begun on the production ERP ECC systems and the key performance threshold has been exceeded for 3 consecutive minutes.
4.) When CPU resources are required an administration request is written to another “in memory” table. The contents of the request are determined by the built in analysis intelligence and dictates the nature of the changes that are required. In this example the analysis intelligence determines that CPU resources should be acquired from a logical partition that does not require all of its CPU resources and re-deployed to the production ERP ECC system to aid in the month end processing.
5.) The current logical partition configuration (CPU and physical memory) for all logical partitions is also written to an “in memory” table. For this example 5 CPU's and 24 GB of physical memory are recorded for the production ERP ECC logical partition and 10 CPUs and 32 GB of physical memory are recorded for the production CRM system.

### Master Module: Administration and Tuning

### Sub Module: Task Logic

6.) The Task Logic Sub Module reads the “in memory” admin request table at 5 second intervals. When a new record is encountered its key is used to retrieve the appropriate admin task from the Admin Instruction Data table along with the corresponding parameters that are required to perform the administration task. In this example the identified task is to add CPU resources to the logical partition that is hosting the ERP ECC production system.
7.) The Task Logic Sub Module then calls the Resource Calculation Sub Module which is a component of the Cloud Control Master Module sending parameters that specify admin task to be performed and where it is to be carried out.

### Master Module: Cloud Control

### Sub Module: Resource Calculation

8.) The Resource Calculation Sub Module determines that the production ERP ECC logical partition requires more CPU resources based on the parameters received from the Task Logic Sub Module. The SAPS consumption trend analysis that triggered the need for more CPU resources and the current logical partition configuration (CPU and RAM) are read from the “in memory tables” that were loaded in steps 4 and 5. Data is also pulled from the SAPS Benchmark Reference Table and calculations are performed that will determine how much additional CPU required to continue to provide for optimal performance and maximum throughput. In this example the calculations indicate the 2 additional CPU resources are required for production ERP ECC system. And that the best logical partition to obtain them from is the production CRM system.
9.) Calculations are performed that determines from which logical partition the CPU resources should be taken. In this example the production CRM logical partition has the most unused CPU resources.
10.) Based on information calculated in steps 11 & 12 and data retrieved from the Admin Instruction Data table in step 6 the Change Validation Sub Module which is a component of the Accounting Master Module, is invoked. Sending parameters that specify the detail of the admin task to be performed.

### Master Module: Accounting Master Module

### Sub Module: Change Validation

11.) Referencing the parameters passed by the Resource Calculation Sub Module that specify the detail of the admin tasks to be performed, the potential changes are recorded in the Change Validation table. This recording of the planned changes are logged before the changes are actually made so that regulatory requirements that dictate all changes be documented prior to them being made can be satisfied.

### Master Module: Cloud Control

### Sub Module: Dynamic Resource Allocation

12.) XML documents that specify the required CPU changes are generated. These XML documents are used for interfacing with the specific resource allocation application that will be used to make the required changes. In this example XML documents are generated that will instruct the IBM-TSAM application to manage the movement of 2 CPUs from the production CRM system to the production ERP ECC system.
13.) The generated XML documents are transferred through the proprietary TSAM gateway to the IBM TSAM server.
14.) IBM TSAM integrates with the VIO server's hypervisor to make the changes outlined in the XML document. In this example 2 CPUs are moved from the production CRM logical partition to the logical partition hosting the production ERP ECC system.
15.) The Error Checking Sub Module queries the VIO servers hypervisor logs to determine if the changes were made successfully.
16.) The Error Checking Sub Module then calls the Change Validation sub Module component of the Accounting Master Module so that changes can be logged properly

### Master Module: Accounting Master Module

### Sub Module: Change Validation

17.) The change records that were created in step 11 are updated with an indication as to whether the change was successful or not.

### Master Module: Accounting Master Module

### Sub Module: Audit Trail

18.) The Audit Trail Sub Module logs all aspects of the change along with the success factor.

### Memory Analysis and Tuning Flow:

Most SAP applications tend to be very memory intensive which often times leads to performance degradation if left unchecked for extended periods of time or left untreated.

There are many methods in which the Central Intelligence Engine of the Cloud*Innovator suite will tune memory resources based on consumption. The method used depends on the specifics of the condition and operational mode used to generate the change process (manual, automated, and scheduled). The process flow below is based on the automated mode with the following scenario (refer to FIG. 5B):

### Scenario Details

### Example Condition:

When the limit that is set on the SAP Extended Memory area is reached the performance of the SAP system begins to degrade significantly, often to the point where the system becomes unusable for a period of time. It is essential that the SAP Extended Memory area be monitored on a consistent basis and its upper limit expanded before unexpected increases in workload cause a full depletion condition. The Cloud*Innovator invention continuously monitors the SAP Extended Memory area and adjusts it automatically if and when required. This approach of self-healing is handled through the proactive monitoring of each system and the auto-provisioning of additional memory resources required to maintain proper health and performance.

### Master Module: Monitoring and Analysis

### Sub Module: Memory Monitoring and Tuning Analysis

1.) Performance statistics are collected for each SAP system in the landscape and stored in the central statistics repository of the SAP Solution Manager system. This part of the overall process is performed by SAP and is non proprietary.
2.) Data that details the current memory configuration and allocation for all SAP systems is collected using the proprietary agents that are resident on each of the SAP systems in the landscape and stored within the “in memory” configuration table for every SAP system in the landscape using proprietary agents and stored within an “in memory” table.
3.) The memory utilization for each of the memory areas that are critical to maintaining SAP system performance and stability are examined at 5 second intervals. The three key memory areas that are checked as part of this analysis are SAP Extended Memory, SAP Roll Memory, and SAP Page Memory. The usage of each of these memory areas is compared to the amount of memory that has been allocated for each and checked against threshold values that are read from the proprietary Configuration and Threshold tables. In this example the volume of SAP Extended Memory that is consumed has exceeded the threshold value at which the allocation should be expanded (refer to FIG. 6A). If this check is not performed and the SAP Extended Memory becomes fully depleted the performance of the SAP system can significantly degraded. When any threshold is exceeded an alert and admin request is created.
4.) When an alert is generated by one of the checks the Memory Monitoring and Tuning Analysis sub module then needs to determine if there is enough physical memory so to allow for the expansion of the allocation of SAP Extended Memory without increasing the use of swap space (inefficient disk usage for memory processing). This is accomplished by mapping the current allocation of memory for the SAP system (refer to FIG. 6B). The figure below shows a Cloud*Innovator memory map for our example application server. There are 2 GB of unallocated memory. This means that the SAP Extended Memory can be increased by up to 2 GB.
5.) If there is enough unallocated memory available that will allow for the extension of SAP Extended Memory, a change request is created and loaded within an “in memory” table and control is passed to the Task Logic Sub Module. If there is not enough unallocated memory a check of all other memory areas is performed in order to determine if some memory can be allocated from another area that is over allocated at a given time. For this example there is enough unallocated memory to allow for extension of SAP Extended Memory.

### Master Module: Administration and Tuning

### Sub Module: Task Logic

6.) The Task Logic Sub Module reads the “in memory” admin request table at 5 second intervals. When a new record is encountered its key is used to retrieve the appropriate admin task from the Admin Instruction Data table along with the corresponding parameters that are required to perform the administration task. In this example the identified task is to extend the amount of memory that can be used for SAP Extended Memory.

### Master Module: Administration and Tuning

### Sub Module: Memory Calculations Sub Module

7.) The Memory Calculations Sub Module takes input from the “in memory” tables relating to memory area impacted, current allocation of memory area, and depletion level and performs the appropriate memory calculation based on specific condition. In this example the memory calculation determines how much more memory can be used for SAP Extended Memory.

### Master Module: Administration and Tuning

### Sub Module: Task Logic

8.) The specifics of the admin tasks to be performed (Increase the amount of memory that can be used for SAP Extended Memory) are used to create instructions that will be carried out by the proprietary agents that are installed on the SAP system to which the change applies.

### Master Module: Accounting Master Module

### Sub Module: Change Validation

9.) Referencing the parameters passed by the Memory Allocation and Analysis Sub Module that specify the detail of the admin tasks to be performed, the potential changes are recorded in the Change Validation table. This recording of the planned changes are logged before the changes are actually made so that regulatory requirements that dictate all changes be documented prior to them being made can be satisfied.

### Master Module: Administration and Tuning

### Sub Module: Task Logic

10.) The admin task command is sent to the proprietary agents that will perform the change to the applicable SAP system. In this example the applicable system is the Production ERP ECC system.

### Proprietary Cloud*Innovator Agents

11.) The agents perform the changes that are required on the applicable SAP system. In this example the parameter that specifies how much memory can be used for SAP

Extended Memory is changed and processes are recycled in order to apply the change.

12.) The proprietary agent sends a message to the Error Checking Sub module that indicates whether the change was successful. In this example the change was successful.

### Master Module: Accounting Master Module

### Sub Module: Change Validation

13.) The change records that were created in step 8 are updated with an indication as to whether the change was successful or not.

### Master Module: Accounting Master Module

### Sub Module: Audit Trail

14.) The Audit Trail Sub Module logs all aspects of the change along with the success factor

### CONCLUSION

The Industry is calling for better economies and services as it relates to their Enterprise application investments and is looking to embrace technological advancements made in the area Cloud Computing to help them get there. Cloud will help transform the way in which these companies do business and will have an event more profound impact on how these services will be delivered. Most IT organizations will be faced with immediate challenges as they embark on the mammoth undertaking to move their traditional static ERP landscapes to a highly virtualized dynamic Cloud model. One of the biggest barriers they will most likely face as they navigate through the disparate layers of technology is the depth of skill and knowledge required to delve into the intricacies of these seemingly silos of expertise. Due to this high degree of complexity many organizations will opt for outside professional help to derive a strategy and provide solutions. Unfortunately there is no de facto standards available at this time, so most of the solutions and services available today are only half baked and do not meet the ultimate goals and expectations of the business community.

Cloud*Innovator is an invention designed to help IT organizations rise to the challenge of Cloud enabling their SAP systems landscape and realizing the rich benefits of a fully virtualized environment. The goal of Cloud*Innovator is to harness the meaning and power of what the Cloud Computing model has to offer the SAP community while shielding the underlying complexities. The Cloud*Innovator invention contains deep insight into each layer of the technology stack and through a panoramic view brings into focus the real business value of what the Cloud has to offer. Unlike other solutions being market today, Cloud*Innovator is not limited to the routine tasks of auto-provisioning new sandbox environments or cloning a test system, but rather delivering real process and control over the entire landscape including production in a fully automated fashion. The key ingredient to make this possible is the creative design and use of built-in Intelligence that automatically orchestrates the necessary actions required at run-time to manage all system resources based on customer defined rules and best practices. This unique design provides an entirely new dimension of automation not currently available today and ensures maximum transparency to the end users. Please see FIG. 5A for information on the benefits and features of the Cloud*Innovator invention.

The proprietary features that differentiate Cloud*Innovator from any other solution in the market today is as follows:

Built-in Intelligence suite to manage all aspects of the dynamic allocation of system resources

Built-in Customer defined Business Rules used to help govern the run-time decision logic

Built-in Best Practices by application and platform used to help govern the run-time decision logic

Self-generated Trending Analysis used to help govern the run-time decision logic

Includes three modes of operation including—1. Manual, 2. Scheduled, and 3. Auto-pilot

Advanced Monitoring and interpretation of real-time statistics including ABAP and JAVA stacks

Advanced reporting metrics of the health and performance of the systems landscape

Advanced reporting features for customer defined SLA's, Metering components, and historical trending analysis

Planning and analysis capabilities used to generate sizing recommendations for various what-if scenarios

Ability to manage the entire systems landscape including production, non-production, and disaster recovery.

1. Cloud*Innovator monitoring service, a proprietary intelligence component (of the overall invention) seamlessly integrated within the native application (SAP) technology framework, is to continuously monitor SAP application level systems performance. Real-time monitoring and tuning is done based on comprehensive automated analysis, which includes decision making logic to streamline the management process eliminating the need for time consuming manual analysis and unexpected systems downtime.

2. The monitoring service of claim 1 wherein said invention comprises of proactive monitoring components known as Monitoring Probes used for continuous polling and advanced analysis of all system resources within the overall landscape according to 246 separate health checks and raise any alerts by passing on the system conditions to the corresponding Smart Module for further analysis and processing.

3. The monitoring service of claim 1 wherein said invention comprises of utility scripts known as Live Agents installed on each individual system within the overall landscape and is used to provide a gateway for the Monitoring Probes to perform proactive monitoring of system activities and performance.

4. The monitoring service of claim 1 wherein said invention comprises of application subroutines known as Smart Modules providing real-time Monitoring and Analysis logic used to automatically streamline the process of gathering crucial systems metrics and statistics used for making mission critical tuning decisions to ensure optimal systems performance.

5. Cloud*Innovator metering service, a proprietary intelligence component (of the overall invention) is fully integrated into the infrastructure landscape to provide accurate real-time metering of all systems resource utilization including CPU, Memory, SAN, and Network Bandwidth.

6. The metering service of claim 5 wherein said invention features auto-generated historical trending analysis that used to aid in the real-time decision making logic based on previous processing trends for Month End, Quarter End, Year End, Seasonal, and other predefined periods.

7. The metering service of claim 5 wherein said invention comprises of software application subroutines known as Smart Modules with real-time Accounting logic used to accurately meter and report on all systems activities and compare actual systems performance against pre-defined service level targets.

8. The metering service of claim 5 wherein said invention comprises of proprietary intelligence logic used to auto-generate Advanced Reporting capabilities including trending analysis of all automated changes made to the systems landscape and custom defined metering elements.

9. The metering service of claim 5 wherein said invention comprises of proprietary intelligence logic used to auto-generate Change Validation services for the logging and tracking of all system updates to meet defined regulatory compliance requirements and general change control management.

10. The metering service of claim 5 wherein said invention comprises of proprietary intelligence logic used to auto-generate Audit Trail services for the logging and tracking of all details of system changes including time and date stamps and other critical tracking information.

11. Cloud*Innovator automation service, a proprietary intelligence component (of the overall invention) is integrated across the entire SAP application and infrastructure landscape to consistently deliver automated provisioning of computing resources and self-tuning of system parameters to ensure overall optimal systems performance.

12. The automation service of claim 11 wherein said invention comprises of a proprietary Portal Control Manager used to select and input all customer specific business rules, manually override automated system changes, launch reports and queries, and submit planning and simulation scenarios.

13. The automation service of claim 11 wherein said invention comprises of event based customer defined business rules used to aid in the real-time decision making logic to ensure optimal governance of systems resource management.

14. The automation service of claim 11 wherein said invention comprises of intellectual best practices according to application standards used to aid in the real-time decision making logic to ensure optimal governance of systems resource management.

15. The automation service of claim 11 wherein said invention comprises of application subroutines known as Smart Modules with real-time Administration, Tuning, and Cloud Control logic used to auto-provision the necessary system resources to avoid performance degradation and unexpected systems downtime.

16. The automation service of claim 11 wherein said invention comprises of utility scripts known as Live Agents installed on each individual system within the overall landscape and is used to carry out the self-corrective auto-provisioning of systems resources as determined by the corresponding Smart Modules to maintain optimal performance.

17. The automation service of claim 11 wherein said invention comprises of proprietary intelligence logic used to auto-generate Planning and Simulation models according to best practices and available system resources in response to various use-case scenarios requested in anticipation of systems growth factors including upgrades, rollouts, and additional functionality.
